(19) United States
(12) Patent Application Publication
(10) Pub. No.: US 2016/0197955 A1
(43) Pub. Date: Jul. 7, 2016

(54) System and Method for Automatic Detection of Attempted Virtual Function Table or Virtual Function Table Pointer Overwrite Attack

(71) Applicant: LEVIATHAN, INC., Seattle, WA (US)

(72) Inventor: Mikhail Davidov, Seattle, WA (US)

(73) Assignee: LEVIATHAN, INC., Seattle, WA (US)

(21) Appl. No.: 14/798,667

(22) Filed: Jul. 14, 2015

Related U.S. Application Data
(60) Provisional application No. 62/024,877, filed on Jul. 15, 2014.

(51) Int. Cl. H04L 29/06; G06F 11/07

(52) U.S. Cl. CPC H04L 63/1466; H04L 63/1425; G06F 11/0778; G06F 11/079

(57) ABSTRACT

System, method and media are shown for automatically detecting an attempted V-table exploit based attack involving receiving crash dump data relating to a fault event, identifying code instructions and associated parameters in the crash dump data, analyzing the identified code instructions and associated parameters to detect whether an instruction with a dynamic branch fault is present in the crash dump data, if a dynamic branch fault is found, analyzing the instruction with the dynamic branch fault for invalid data relating to the dynamic branch, and generating an alert if the instruction with the dynamic branch fault includes invalid data. Some examples include automatically sending a message to a network administrator indicating a type of attack and a code module or instruction that faulted. Other examples include automatically triggering system defenses to respond to the attack includes at least one of limiting and blocking access to vulnerable code.

### CROSS REFERENCE TO RELATED APPLICATIONS

This application claims the benefit of U.S. Provisional Patent Appl. No. 62/024,877 for “System and Method for Automatic Detection of Attempted Virtual Function Table or Virtual Function Table Pointer Overwrite Attack” filed Jul. 15, 2014, herein incorporated by reference in its entirety for all purposes.

### GOVERNMENT LICENSE RIGHTS

This invention was made with government support under FA8750-12-C-0161 awarded by the United States Air Force. The government has certain rights in the invention.

### BACKGROUND

Computer networks and the devices and services that reside on them are often the subject of attacks by parties that are attempting to improperly access information and resources or to introduce malicious code to the networks. The attackers who are threats to information technology infrastructure assets and to the confidentiality of information stored in them may come from a wide variety of different sources, with different motives, levels of sophistication, available resources, and expertise.

### SUMMARY

In accordance with certain aspects of the present invention, a process is shown for inferring that an application crash is the result of failed malicious activity, and more particularly of attempted virtual function table (V-table) corruption, from the condition where the instruction at which the program fault causing the crash occurred was a call instruction referencing a location in memory referenced by both a base and an index.

An embodiment of a method for automatically detecting an attempted V-table exploit based attack, in accordance with certain aspects of the present invention, the method calls for receiving crash dump data relating to a fault event and identifying code instructions and associated parameters in the crash dump data. The method also involves analyzing the identified code instructions and associated parameters to detect whether an instruction with a dynamic branch fault is present in the crash dump data. If a dynamic branch fault is found, the method sets forth analyzing the instruction with the dynamic branch fault for invalid data relating to the dynamic branch and generating an alert if the instruction with the dynamic branch fault includes invalid data. Some examples include automatically sending a message to a network administrator indicating a type of attack and a code module or instruction that faulted. Other examples include automatically triggering system defenses to respond to the attack includes at least one of limiting and blocking access to vulnerable code.

An embodiment of a system for automatically detecting an attempted V-table exploit based attack, in accordance with certain aspects of the present invention, includes means for receiving crash dump data relating to a fault event and means for identifying code instructions and associated parameters in the crash dump data. The system further includes means for analyzing the identified code instructions and associated parameters to detect whether an instruction with a dynamic branch fault is present in the crash dump data. The system also includes means for analyzing the instruction with the dynamic branch fault for invalid data relating to the dynamic branch if a dynamic branch fault is found and means for generating an alert if the instruction with the dynamic branch fault includes invalid data.

### BRIEF DESCRIPTION OF THE DRAWINGS

Various embodiments in accordance with the present disclosure will be described with reference to the drawings, in which:

FIG. 1 is a schematic diagram depicting an example of a computer network based system that may be subject to attack and may be suitable for utilization of certain aspects of the present invention;

FIG. 2 is a schematic diagram illustrating an example of a V-table structure;

FIG. 3 is a schematic diagram illustrating an example of a V-Table based attack on the V-table structure of FIG. 2;

FIG. 4 is a control flow diagram illustrating one example of a process for automatically detecting a V-table based attack in accordance with certain aspects of the present invention;

FIG. 5 depicts aspects of elements that may be present in a computer device and/or system configured to implement a method, system and/or process in accordance with certain aspects of the present invention.

Note that the same numbers are used throughout the disclosure and figures to reference like components and features.

### DETAILED DESCRIPTION

The subject matter of embodiments of the present invention is described here with specificity to meet statutory requirements, but this description is not necessarily intended to limit the scope of the claims. The claimed subject matter may be embodied in other ways, may include different elements or steps, and may be used in conjunction with other existing or future technologies. This description should not be interpreted as implying any particular order or arrangement among or between various steps or elements except when the order of individual steps or arrangement of elements is explicitly described.

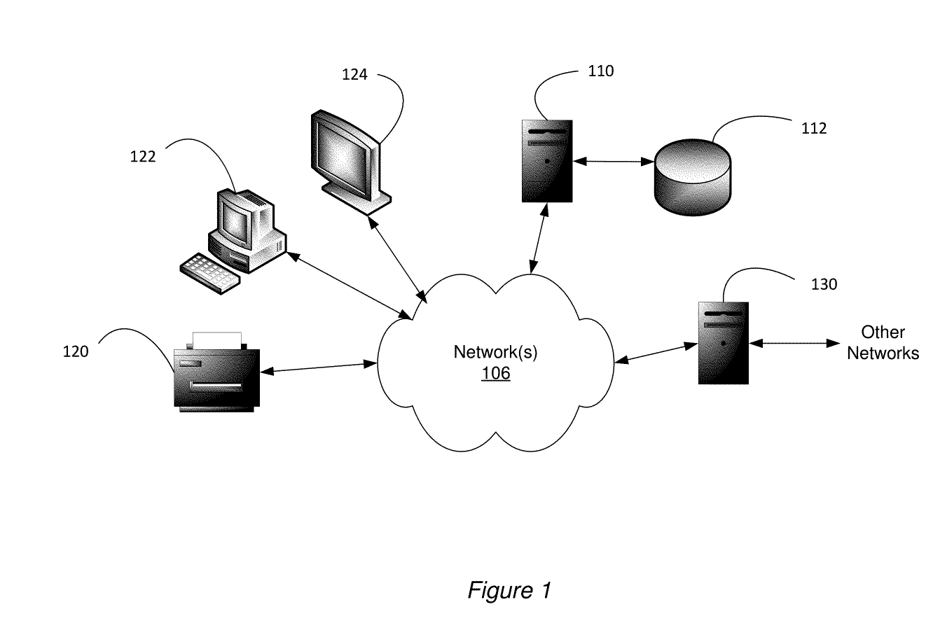

FIG. 1 is an architecture diagram that depicts aspects of an example of a computer network system with communication among multiple devices. In this example, network 106, which can be one network or multiple networks, provides communication between server 110 connected to database 112 and several client devices, such as printer 120, personal computer 122, and interactive terminal 124. The architecture of FIG. 1 is a simplified representation of an enterprise environment having a multitude of different computing devices that may represent a target for an attack. A gateway 130 provides a communications link between the network 106 and other networks, such as the internet, through which an attacker may launch an attack. The open nature of computer networks exposes code vulnerabilities that are frequently targeted for attack by hackers and malicious actors to gain improper access to systems.

Some vulnerabilities arise out of the use of certain programming models. Subtype polymorphism, often called just polymorphism in the context of object-oriented programming, is the ability of one data type, A, to appear as and be used like another type, B. The purpose of polymorphism is generally to implement a style of programming called message-passing, in which objects of various types define a common interface of operations for users. In strongly typed languages, polymorphism usually means that type A somehow derives from type B, or type C implements an interface that represents type B. In weakly typed languages, types are implicitly polymorphic.

The primary usage of polymorphism in object-oriented programming is the ability of objects belonging to different types to respond to method, field, or property calls of the same name, each one according to an appropriate type-specific behavior. The programmer, or the program, does not have to know the exact type of the object in advance, and so the exact behavior is determined at run-time, which is called late binding or dynamic binding.

The different objects involved typically only need to present a compatible interface to the clients, e.g. calling routines. That is, there are public or internal methods, fields, events, and properties with the same name and the same parameter sets in all the superclasses, subclasses and interfaces. In principle, the object types may be unrelated. But since they share a common interface, they are often implemented as subclasses of the same superclass. Though it is not required, it is understood that the different methods will also produce similar results, such as returning values of the same type.

When object polymorphism is used in computer programming, it is necessary to store a reference to the subtype-specific behaviors of each instance of a polymorphic object. In most cases this is implemented as a table of pointers to functions implementing the specific behaviors, beginning each instance, which is called a virtual table or V-table. Generally, in x86 and other processor architectures, the calls to such functions are made relative to the position of the object in memory, such that the operand for the call is a dereferenced memory operand in base-displacement-index form, e.g. in x86, a SIB byte with a nonzero displacement is used.

Many common software vulnerability exploitation techniques overwrite these V-tables, so that the desired behavior is triggered when a method in the partially overwritten object instance is called. Vulnerable code may inadvertently increment a V-table pointer to point to an unaligned address within the V-table's function points. This leads to the program counter being set to an address that is not within another module. If the memory has been sprayed with many instances of malicious code, e.g. salted in data memory, then the program counter may pass control to an instance of the attacker's code.

For example, V-table pointer overwrites are a common attack vector for software written in C++. When C++ objects are allocated on the heap, such as when the “new” keyword is used, they often get put next to other objects that are also on the heap. If there is an unbounded write to one of the objects on the heap before an object using V-tables, an overwrite type of attack is feasible. Operating systems typically include mitigation techniques that can make it difficult to guess which objects will be next to each other on the heap, e.g. the Windows heap manager. Even if an attacker knows that there is an unbounded write to an object on the heap, the attacker does not know what object is in sequence after it on the heap, making it much more difficult to use this exploit reliably.

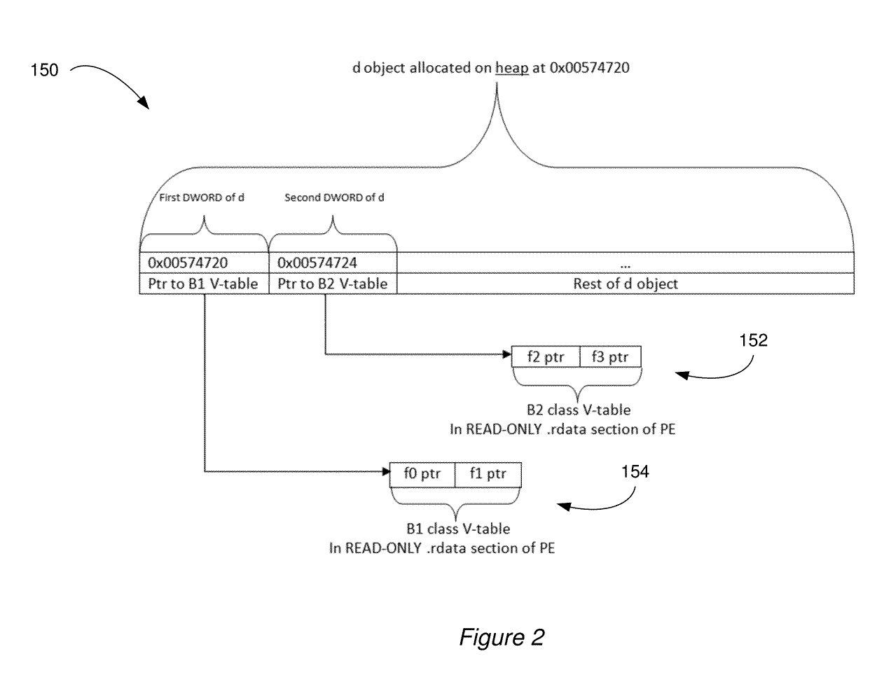

FIG. 2 is a graphical depiction of an example of a heap showing a relationship between an object d 150 allocated on the heap at address 0x00574720 and V-tables 152 and 154 that object d references. The first Dword of the d object 150 points to a B1 class V-table 154 that resides in a read-only .rdata section of memory and includes pointers to functions f0 and f1. The second Dword of object d 150 points to a B2 class V-table 152 that also resides in the read-only .rdata section of memory and includes pointers to functions f2 and f3.

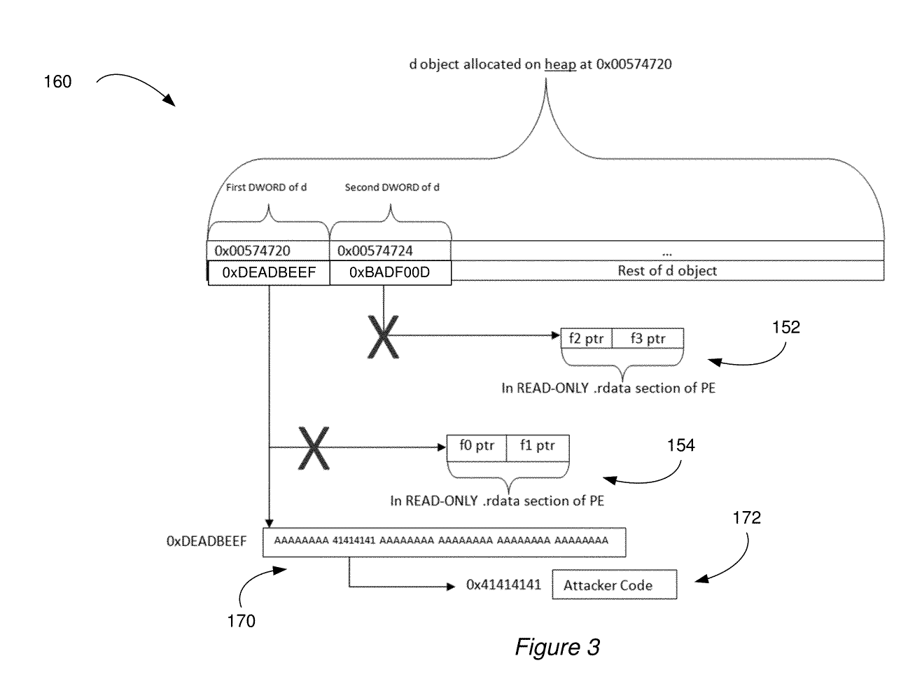

In this example, in order to use a V-table pointer overwrite exploit to hijack a call to d->f1( ), a “fake V-table” and attacker code must be in place in memory before executing the call. For this example, assume the “fake V-table” is at 0xDEADBEEF and the attacker code is at 0x41414141. This can be achieved by memory spraying to establish the following: 1) Address 0xDEADBEEF has already been allocated and is readable; 2) The DWORD at 4 bytes past 0xDEADBEEF, e.g. 0xDEADBEF3, is the address of attacker code that the exploit is trying to execute; and 3) the attacker code exists at 0x41414141. The exploit is to overwrite the pointer, which is stored in the heap-allocated object, to the B1 class V-table 154 with the value 0xDEADBEEF. Here, the pointer to the B1 V-table, which is stored at 0x00574720, is overwritten with the value 0xDEADBEEF. FIG. 3 illustrates the resulting overwritten V-table pointers with sprayed fake V-table 170 and attacker code 172. (See http://neilscomputerblog.blogspot.com/2013/02/attacking-v-table-pointers.html for further details relating to this example.)

However, there is an inherent degree of uncertainty in the exploitation of software vulnerabilities. There is a significant probability that exploits using this technique will fail and cause a fault in the target program by, for example, calling a branch to an invalid location, or attempting to dereference memory that cannot be dereferenced. In this case, the fault event will generate a crash dump, which records a snapshot of the memory state when the fault occurs. If the faulting instruction in a crash dump is a branch to an offset stored in memory and referenced in base-displacement-index form, then it can be inferred that there is an increased probability that the program fault was caused by a V-table-overwrite-based exploitation attempt.

Generally, a branch with a dynamic address, e.g. typically a displacement times an index plus a base, is based on a V-table. If a dynamic branch itself faults because the destination address is invalid, then it is likely that the reason is a V-table overwrite with invalid data. Additionally, if a dynamic branch results in the instruction pointer pointing to an invalid instruction, it is also likely that the reason is a V-table overwrite with invalid data. Invalid data, for example, is an address that either points to uncommitted or otherwise non-executable memory or points to executable memory at an offset from which the code pointed to is not executable. In the former case, the branch instruction in question may be a dynamic branch of any type. In the latter case, the branch instruction in question is one that intrinsically stores a return address (e.g. an x86 CALL instruction). If that condition does not hold (i.e. it is a jump without return), then the determination of whether the fault was caused by a dynamic branch is likely not possible from the snapshot of state alone.

Another example is a buffer overflow exploit. The attacker will attempt to position an overflowable buffer before some other object on which they can cause a dynamic method to be called. Then they overflow the buffer in such a way that the second object's V-table, which is located at the start of the object, will be overwritten with data of the attacker's choosing, e.g. the address of the attacker's shellcode. If the exploit is successful, then the dynamic call will branch execution to the shellcode. If the attacker has incorrectly calculated or guessed the length of the first object or alignment of the second object in relation to the first, or otherwise miscalculates the offset of the vtable of the second object, then it is likely that a crash will result when a (late-bound) method is called on the second object. This crash will either occur on the attempt to call the corrupted function pointer, or, if the pointer points to a valid location but the instruction stream is not valid at the destination, on the very next instruction. There is an edge case where one or more valid instructions exist (by random happenstance) at the (corrupt, random) branch entry point. In this case, as long as the stack is invariant until a fault occurs and the fault is that an invalid instruction is encountered and the vtable call was a dynamic call instruction (i.e. pushes the return address intrinsically), then the exploit may still be detected in accordance with the present invention. If the stack is not invariant, or the crash was due to some reason besides an invalid instruction, then the exploit may not be detectable.

While there are certainly other possible reasons for a fault event (such as benign memory corruption or a bad index value causing a bad V-table dereference, or a bad index value on an array of function pointers), a crash dump showing a branch of these types or similar types has a great likelihood of corresponding to a V-table-overwrite exploit.

An embodiment of the present method checks whether the faulting instruction is a branch with a dynamic destination, or whether the faulting instruction is invalid and the instruction preceding that pointed to by the first address on the stack (that being a return address, if the condition is to be true) is a branch with a dynamic destination. If either of these conditions holds, there is an elevated probability that there was a failed attempt to exploit the program using a V-table overwrite.

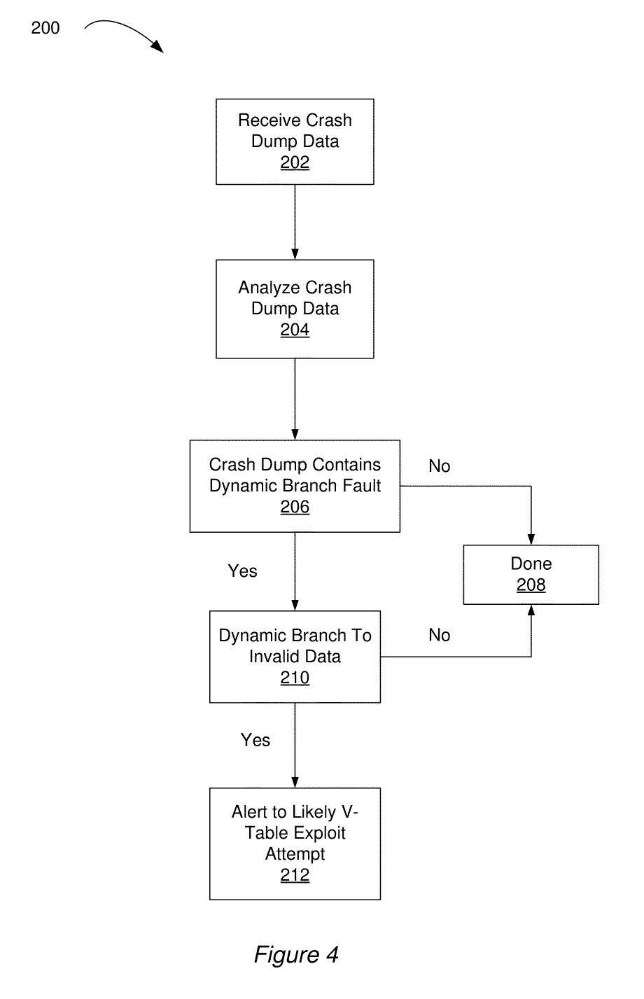

FIG. 4 is a control flow diagram illustrating one example of a process 200 for processing a crash dump to detect an attempted V-table exploit based attack in accordance with certain aspects of the present invention. At step 202, the crash dump for a fault event is received and is analyzed at step 204 where the crash dump data may be reverse assembled or similarly processed such that the code instructions in the crash dump are recovered along with their parameters, e.g. branch with destination address or index. At step 206, the code instructions and addresses are scanned to determine whether a dynamic branch fault is present in the crash dump data. It is generally correct to infer that branches with a dynamic address, e.g. typically a displacement times an index plus a base, are based on a V-table. If there is no dynamic branch fault in the crash dump data, then the V-table fault analysis ends and control branches to step 208.

If there is a dynamic branch fault, then control flows to step 210, where the dynamic branch is checked for invalid data. For example, if a dynamic branch itself faults because the destination address is invalid, then it is likely that the reason is a V-table overwrite with invalid data. In another example, if a dynamic branch results in the instruction pointer pointing to an invalid location or invalid instruction at a dereferenceable location, then it is also likely that the reason is a V-table overwrite with invalid data. Invalid data, for example, is an address which either points to uncommitted or otherwise non-executable memory, or to executable memory at an offset from which the code pointed to is not executable.

If a dynamic branch to invalid data is found in the crash dump data at step 210, then control flows to step 212, where an alert is raised that a likely V-table exploit attempt has occurred. The alert may be used to automatically send a message to a network administrator, such as an email with the crash dump data, the reverse compiled code and text indicating the type of attack and the code module or instruction that faulted. The alert may be used to automatically trigger system defenses to respond to the attack, such as limiting or blocking access to the vulnerable code module. The alert may be used for a variety of responses.

In accordance with at least one embodiment of the invention, the system, apparatus, methods, processes and/or operations described herein may be wholly or partially implemented in the form of a set of instructions executed by one or more programmed computer processors, such as a central processing unit (CPU) or microprocessor. Such processors may be incorporated in an apparatus, server, client or other computing device operated by, or in communication with, other components of the system. In accordance with another embodiment of the invention, the system, apparatus, methods, processes and/or operations described herein may be wholly or partially implemented in the form of a set of processor executable instructions stored on persistent storage media.

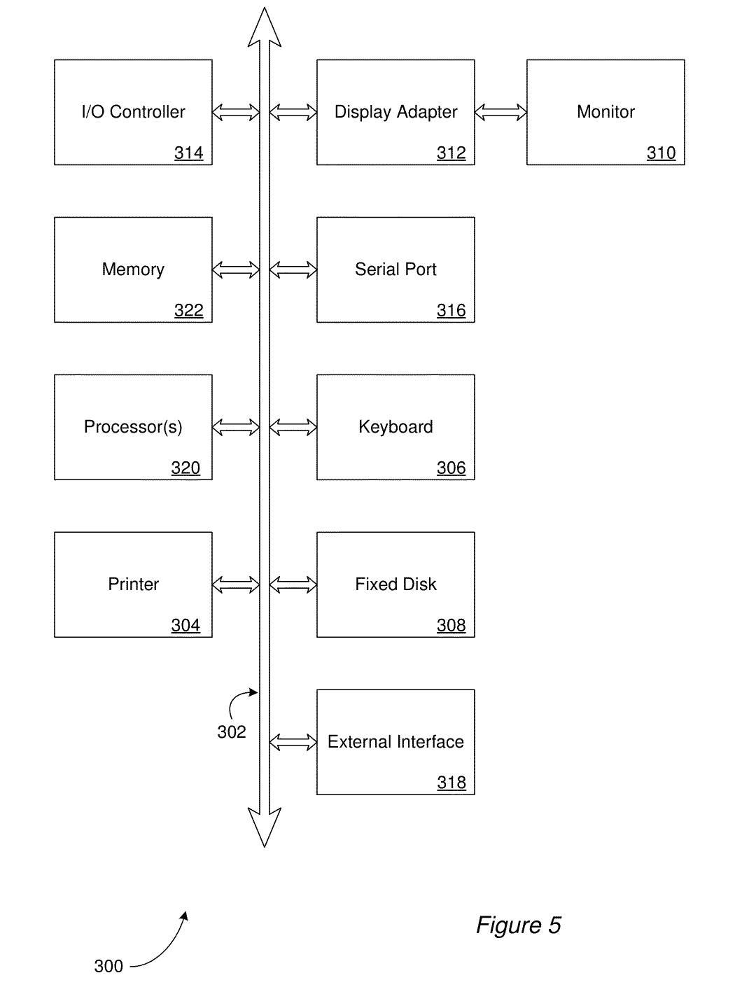

FIG. 5 depicts aspects of elements that may be present in one example of a computer device and/or system 300 configured to implement at least some elements of a method, system and/or process in accordance with some embodiments of the present invention. The subsystems shown in FIG. 5 are interconnected via a system bus 302. Additional subsystems include a printer 304, a keyboard 306, a fixed disk 308, and a monitor 310, which is coupled to a display adapter 312. Peripherals and input/output (I/O) devices, which couple to an I/O controller 314, can be connected to the computer system by any number of means known in the art, such as a serial port 316. For example, the serial port 316 or an external interface 318 can be utilized to connect the computer device 300 to further devices and/or systems not shown in FIG. 5 including a wide area network such as the Internet, a mouse input device, and/or a scanner. The interconnection via the system bus 302 allows one or more processors 320 to communicate with each subsystem and to control the execution of instructions that may be stored in a system memory 322 and/or the fixed disk 308, as well as the exchange of information between subsystems. The system memory 322 and/or the fixed disk 308 may embody a tangible computer-readable medium.

It should be understood that the present invention as described above can be implemented in the form of control logic using computer software in a modular or integrated manner. Based on the disclosure and teachings provided herein, a person of ordinary skill in the art will know and appreciate other ways and/or methods to implement the present invention using hardware and a combination of hardware and software.

Any of the software components, processes or functions described in this application may be implemented as software code to be executed by a processor using any suitable computer language such as, for example, Java, C++ or Perl or using, for example, conventional or object-oriented techniques. The software code may be stored as a series of instructions, or commands on a computer readable medium, such as a random access memory (RAM), a read only memory (ROM), a magnetic medium such as a hard-drive or a floppy disk, or an optical medium such as a CD-ROM, where the code is persistently stored sufficient for a processing device to access and execute the code at least once. Any such computer readable medium may reside on or within a single computational apparatus, and may be present on or within different computational apparatuses within a system or network.

All references, including publications, patent applications, and patents, cited herein are hereby incorporated by reference to the same extent as if each reference were individually and specifically indicated to be incorporated by reference and/or were set forth in its entirety herein.

The use of the terms “a” and “an” and “the” and similar referents in the specification and in the following claims are to be construed to cover both the singular and the plural, unless otherwise indicated herein or clearly contradicted by context. The terms “having,” “including,” “containing” and similar referents in the specification and in the following claims are to be construed as open-ended terms (e.g., meaning “including, but not limited to,”) unless otherwise noted. Recitation of ranges of values herein are merely indented to serve as a shorthand method of referring individually to each separate value inclusively falling within the range, unless otherwise indicated herein, and each separate value is incorporated into the specification as if it were individually recited herein. All methods described herein can be performed in any suitable order unless otherwise indicated herein or clearly contradicted by context. The use of any and all examples, or exemplary language (e.g., “such as”) provided herein, is intended merely to better illuminate embodiments of the invention and does not pose a limitation to the scope of the invention unless otherwise claimed. No language in the specification should be construed as indicating any non-claimed element as essential to each embodiment of the present invention.

Different arrangements of the components or steps depicted in the drawings or described above, as well as components and steps not shown or described, are possible without departing from the scope of the invention. Similarly, some features and subcombinations are useful and may be employed without reference to other features and subcombinations. Embodiments of the invention have been described for illustrative and not restrictive purposes, and alternative embodiments will be apparent to one of ordinary skill in the art. Accordingly, the present invention is not limited to the embodiments described above or depicted in the drawings, and various embodiments and modifications can be made without departing from the scope of the invention.

We claim:

1. A method for automatically detecting an attempted V-table exploit based attack, the method including the steps:
receiving crash dump data relating to a fault event;
identifying code instructions and associated parameters in the crash dump data;
analyzing the identified code instructions and associated parameters to detect whether an instruction with a dynamic branch fault is present in the crash dump data;
if a dynamic branch fault is found, analyzing the instruction with the dynamic branch fault for invalid data relating to the dynamic branch; and
generating an alert if the instruction with the dynamic branch fault includes invalid data.

2. The method of claim 1, where the step of generating an alert further comprises automatically sending a message to a network administrator indicating a type of attack and a code module or instruction that faulted.

3. The method of claim 2, where the message to the network administrator further includes at least one of crash dump data, reverse compiled code and text.

4. The method of claim 1, where the step of generating an alert further comprises automatically triggering system defenses to respond to the attack.

5. The method of claim 4, where the step of automatically triggering system defenses to respond to the attack includes at least one of limiting and blocking access to vulnerable code.

6. A system for automatically detecting an attempted V-table exploit based attack, the system including:
means for receiving crash dump data relating to a fault event;
means for identifying code instructions and associated parameters in the crash dump data;
means for analyzing the identified code instructions and associated parameters to detect whether an instruction with a dynamic branch fault is present in the crash dump data;
means for analyzing the instruction with the dynamic branch fault for invalid data relating to the dynamic branch if a dynamic branch fault is found; and
means for generating an alert if the instruction with the dynamic branch fault includes invalid data.

7. The system of claim 6, where the means for generating an alert further comprises means for automatically sending a message to a network administrator indicating a type of attack and a code module or instruction that faulted.

8. The system of claim 7, where the message to the network administrator further includes at least one of crash dump data, reverse compiled code and text.

9. The system of claim 6, where the means for generating an alert further comprises automatically triggering system defenses to respond to the attack.

10. The system of claim 9, where the means for automatically triggering system defenses to respond to the attack includes at least one of means for limiting and means for blocking access to vulnerable code.

11. A persistent computer readable medium storing computer code configured to a cause a processing device to operate to automatically detect an attempted V-table exploit based attack, the computer code including instructions that configure the processing device to:
receive crash dump data relating to a fault event;
identify code instructions and associated parameters in the crash dump data;
analyze the identified code instructions and associated parameters to detect whether an instruction with a dynamic branch fault is present in the crash dump data;
if a dynamic branch fault is found, analyze the instruction with the dynamic branch fault for invalid data relating to the dynamic branch; and
generate an alert if the instruction with the dynamic branch fault includes invalid data.

12. The persistent computer readable medium of claim 11, where the instructions configured to cause the processing device to generate an alert includes instructions to cause the processing device to automatically send a message to a network administrator indicating a type of attack and a code module or instruction that faulted.

13. The persistent computer readable medium of claim 12, where the message to the network administrator further includes at least one of crash dump data, reverse compiled code and text.

14. The persistent computer readable medium of claim 11, where the instructions configured to cause the processing device to generate an alert further comprises instructions to cause the processing device to automatically trigger system defenses to respond to the attack.

15. The persistent computer readable medium of claim 14, where the instructions configured to cause the processing device to automatically trigger system defenses to respond to the attack includes instructions to cause the processing device to respond to the attack by at least one of limiting and blocking access to vulnerable code.
